(19) United States
(12) Patent Application Publication
(10) Pub. No.: US 2007/0150492 A1
(43) Pub. Date: Jun. 28, 2007

(54) Method and system for allocating file in clustered file system

(75) Inventor: Hidehisa Shitomi, Mountain View, CA (US)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 11/319,303

(22) Filed: Dec. 27, 2005

(51) Int. Cl. G06F 7/00

(52) U.S. Cl. 707/100

(57) ABSTRACT

Described is a system and algorithm for allocating files in various storage units available within the CFS, as well as a technique for enabling storage system administrator(s) to control the file allocation in Clustered File Systems (CFS). The CFS server may execute one or more file allocation algorithms, which enable the storage system administrator(s) to establish a flexible file allocation policy for allocating storage resources among various storage units in the CFS. To this end, each file server in the CFS includes a file locator module, which operates in accordance with one or more file allocation algorithms, and inter-operates with other similar modules of other file servers in the CFS to exchange information on available storage resources and allocate storage resources within various storage units in the CFS. CFS may be configured to support multiple file allocation policies, which may be selected either automatically or by the storage system administrator(s). The file locator module enables the inventive CFS to implement these file allocation policies. Once the appropriate policy has been selected, the file allocation module performs various file allocation operations according to the selected file allocation policy, and issues the file creation requests to the appropriate CFS server(s).

### DESCRIPTION OF THE INVENTION

1. Field of the Invention

The present invention generally relates to computer storage systems and, more specifically, to clustered file systems.

2. Description of the Related Art

The past thirty years have been marked by significant improvements in the capacity and performance characteristics of computer file systems. Those advances were primarily due to the availability of faster hardware as well as improvements in file system design and architecture. Specifically, during the aforementioned time period, the performance file system technology evolved from Local File System architecture to Distributed File Systems.

FIG. 1 illustrates an exemplary schematic diagram of a Local File System. The Local File System shown in FIG. 1(a) directs all data read and write requests from a user application 3001 executing on a node 3000 to directly attached storage system (DAS) or network attached storages utilizing Fibre Channel or iSCSI (SAN) interconnect interfaces, which are collectively designated in FIG. 1(a) by numeral 3004. As well known to persons of skill in the art, the term direct attached storage refers to a storage system directly attached to a server or workstation, without a storage network in between. One example of a Local File System is an EXT2 file system. As would be appreciated by those of skill in the art, the performance and capacity of the Local File System shown in FIG. 1(a) is limited by the performance and capacity of the computer node 3000 and the directly attached storage system 3004.

A Distributed File System (DFS) is a file system that supports sharing of files and resources in the form of persistent storage over a network. First distributed file systems have been developed as early as 1970's and Sun's Network File System (NFS) became the first widely used distributed file system after its introduction in 1985. Notable distributed file systems besides NFS include Andrew File System (AFS) and Common Internet File System (CIFS). The aforementioned Andrew File System was one of the most successful distributed file systems in the earlier period.

FIG. 1(b) illustrates architecture of a Network File System. The Network File System, such as NFS by Sun Microsystems, which is illustrated in FIG. 1(b), may include a server 5001 executing on a server node 5000 and one or more clients 4002 executing on one or more client nodes 4000. A client 4002 in the Network File System intercepts various file system requests that user applications executing on the client node 4000 send to a local file system of that node, and communicates the intercepted file system requests to the Network File System server 5001 by means of a network communication. The Network File System server sends the file system requests received from a client to a Local File System of the server node 5000. The local storage attached to the server node 5000 may also include attached storage systems (DAS) or network attached storages utilizing Fibre Channel or iSCSI (SAN) interfaces, which are collectively designated in FIG. 1(b) by numeral 5004. It should be noted that while the Network File System architecture provides for sharing of storage resources among different nodes and/or applications, its capacity and performance characteristics are limited similarly to the characteristics of the Local File System.

A Clustered File System (CFS) can be classified as a special type of a distributed file system. CFS has a shared name space among the participating server nodes just like the other types of distributed file systems. One of the distinguishing features of CFS is the scalability of its performance and/or capacity characteristics, which is achieved by the provided facilities for integrating additional server nodes and/or storage units. Specifically, in a CFS configuration, a client is capable of directing various file system operation requests to multiple CFS server nodes in a cluster. By enabling a single file system client to work with multiple file system servers, the CFS achieves the scalability of performance and storage capacity. These features of the CFS render it suitable for applications requiring enhanced input-output performance and capacity characteristics, such as High Performance Computing area applications.

Unfortunately, a file server responding to a client request within a conventional CFS may only allocate storage space within a local file system space of its own node or some other predetermined node. Consequently, a conventional CFS does not enable its administrator to create custom storage allocation rules, and, for this reason, the CFS administrator lacks the ability to perform capacity planning in the CFS. Therefore, what is needed is a flexible file allocation methodology for CFS, which would enable administrators to control the file allocation rules and, in particular, to specify a desired file allocation algorithm and its parameters.

### SUMMARY OF THE INVENTION

The inventive methodology is directed to methods and systems that substantially obviate one or more of the above and other problems associated with conventional techniques for file allocation in clustered file systems.

One aspect of the inventive concept is a method, computer programming product and a computerized system for allocating a file in a clustered file system. The inventive storage system includes a client node executing a user application and a file system client. The file system client is operable to receive a file creation request from the user application and forward this request to a first file server. The inventive system further includes multiple file server nodes executing a file system server and having local file system. The file system server includes a file locator module configured to determine the location of the file within the clustered file system in accordance with a predetermined policy and to forward the file creation request to a second file server associated with the determined file location. The system further includes multiple storage volumes each associated with one of the server nodes and a network interlinking the client node and the file server nodes. The second file server receiving the file creation request from the first file server is operable, in response to the file creation request, to cause a file to be created within a second storage volume.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary schematic diagram of a Local File System;

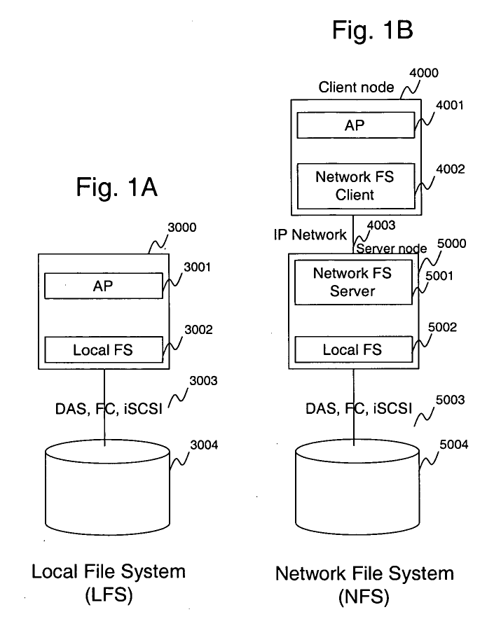

FIG. 2 depicts a conceptual diagram of Clustered File System (CFS) architecture upon which an embodiment of the inventive concept may be implemented;

FIG. 3 illustrates a CFS configuration in accordance with an alternative embodiment of the invention;

FIG. 4 illustrates an inventive file location management configuration;

FIG. 5 illustrates an operating sequence associated with a procedure for reading a file in accordance with an exemplary embodiment of the inventive CFS;

FIG. 6 depicts a conceptual diagram of file creation operation in a CFS;

FIG. 7 presents a conceptual diagram of a file creation sequence in an embodiment of the inventive CFS;

FIG. 8 illustrates an exemplary operating sequence of the inventive file allocation algorithm;

FIG. 9 illustrates an exemplary embodiment of data structures of the inventive file locator module;

FIG. 10 illustrates an exemplary embodiment of the inventive file allocation policy management interface; and

FIG. 11 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

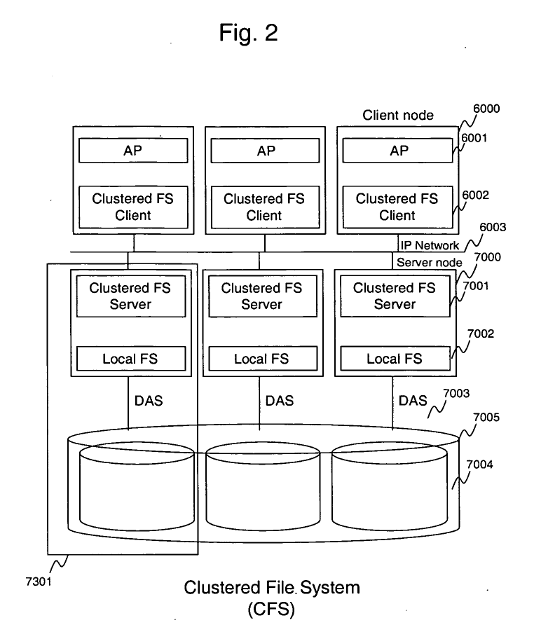

FIG. 2 depicts a conceptual diagram of Clustered File System (CFS) architecture upon which an embodiment of the inventive concept may be implemented. The CFS may include multiple client nodes 6000 as well as multiple file servers 7000. The multiple file servers 7000 of CFS together with the associated storage units 7004 could be considered to form a cluster of interconnected stand-alone Network Attached Storage (NAS) units 7301, which enable a client 6000 of CFS to direct various file system operation requests to any of the CFS servers 7000 in a cluster. By enabling a single file system client to work with multiple file system servers, the CFS achieves the scalability of performance and storage capacity.

The specific CFS system configuration shown in FIG. 2 includes multiple CFS client nodes 6000, multiple CFS server nodes 7000, as well as a storage system 7003, which may be of any suitable type, including, without limitation, DAS, SAN, or NAS. A client node 6000 is a computer system, which may execute a user application (AP) 6001, which performs various file access and manipulation operations. The user application (AP) 6001 accesses the resources of the CFS using a CFS client program 6002, which also executes on the client node 6000. To enable the CFS access by the application program 6001, the CFS client program 6002 communicates with a CFS server program 7001, which executes on the server nodes 7000, through a network communication protocol, such as TCP/IP. To facilitate the aforesaid communication, the CFS client node and CFS server node are connected via a network interconnect, such as LAN 6003.

The CFS Server Node 7000 will now be described in detail. The CFS Server Node 7000 is configured to execute the aforementioned CFS server program 7001, which enables the clients 6000 to access the storage resources. The operating environment of each node 7000 additionally comprises a Local File System (LFS) 7002. In the embodiment shown in FIG. 2, the server node 7000 utilizes Direct Attached Storage (DAS) units 7004 to store and retrieve user data. In an embodiment of the inventive system, a separate file system is created in each DAS unit 7004 on a corresponding server node. The CFS integrates these separate file systems into one logical file system 7005, which enables the user application AP 6001 executing on the client node 6000 to operate in a single name space constructed by the separate file systems.

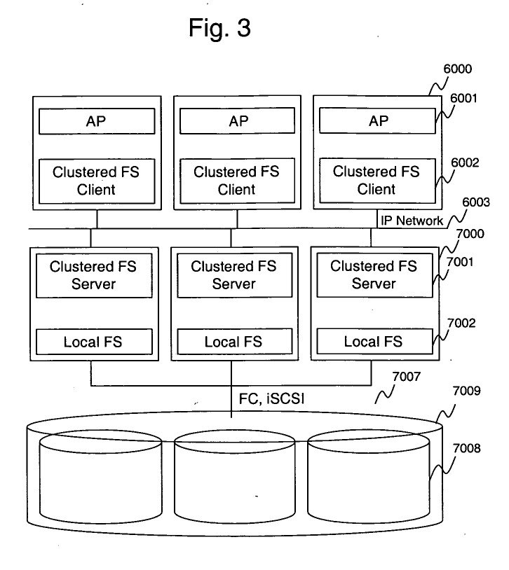

It should be noted that the direct attached storage (DAS) architecture shown in FIG. 2 is only one example of a storage system topology which may be used to implement the inventive concept. That is, in the CFS system configuration shown in FIG. 2, storage subsystems 7004 are directly attached to the corresponding server nodes 7000 implementing the aforementioned DAS topology. The DAS units 7004 attached to different server nodes 7000 of the CFS collectively form one logical file system accessible from all client nodes 6000. While the embodiments of the inventive concept are illustrated herein using the DAS topology shown in FIG. 2, the inventive concept is not limited to any specific configuration of the CFS. In particular, the inventive concept may be implemented upon a number of alternative CFS configurations, such as a configuration shown in FIG. 3. The clustered file system shown in FIG. 3 is similar to the CFS architecture of FIG. 2, with the exception that the DAS configuration 7003 of FIG. 2 is replaced with a network storage system 7007.

Specifically, in the CFS architecture of FIG. 3, storage unit 7009 is connected to the file server nodes 7000 by means of a storage area network (SAN), utilizing, for example, Fibre Channel or iSCSI interconnect systems. The storage device 7009 in FIG. 3 is partitioned into multiple logical storage volumes 7008, which are associated with corresponding file servers 7000. Each of the logical storage volumes 7008 of the storage system 7009 appear to the corresponding file server nodes 7000 as their local file systems. It should be noted that many other CFS architectures and topologies can be used to implement the inventive concept. For example, the server nodes 7000 and the associated storage system components may be arranged in accordance with the network attached storage (NAS) architecture, which is well known to persons of skill in the art. In such a configuration, the server nodes 7000 may additionally be provided with functionality to support the aforementioned NAS configuration and requisite communication protocol(s).

The inventive file allocation methodology will now be described. One aspect of the inventive methodology is an algorithm for allocating files in various storage units available within the CFS, as well as a technique for enabling storage system administrator(s) to control the file allocation in Clustered File Systems (CFS). Specifically, an embodiment of the inventive CFS server may execute one or more inventive file allocation algorithms, which enable the storage system administrator(s) to establish a flexible file allocation policy for allocating storage resources among various storage units in the CFS. To this end, each file server 7001 in the inventive CFS includes a File Locator module, which operates in accordance with one or more file allocation algorithms, and inter-operates with other similar modules of other file servers 7001 in the CFS to exchange information on available storage resources and allocate storage resources within various storage units in the CFS. An embodiment of the inventive CFS may be configured to support multiple predetermined file allocation policies, which may be selected either automatically or by the storage system administrator(s). The aforementioned File Locator module enables the inventive CFS to implement these file allocation policies. Once the appropriate policy has been selected, the file allocation module performs various file allocation operations according to the selected file allocation policy, and issues the file creation requests to the appropriate CFS server(s).

In addition, an embodiment of the inventive CFS server may include a management application programming interface (API) for setting various parameters of the inventive file location algorithms. This storage management API may be implemented in a form of an application programming interface, a graphical user interface or a command line interface. The management interface may be used by storage or server administrators to select one of the existing storage allocation policies and/or set the parameters of the selected policy.

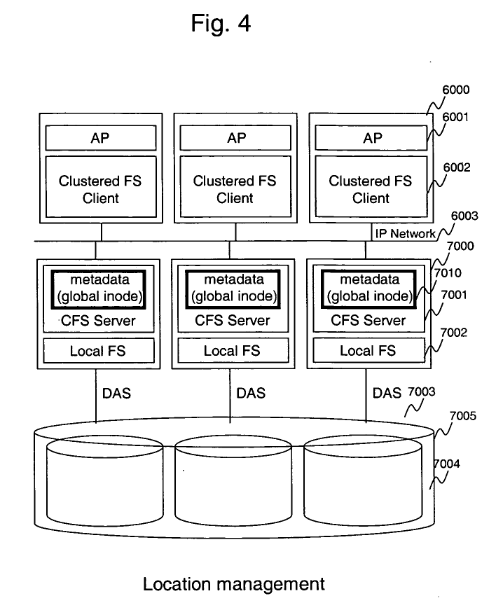

Inventive file location algorithms will now be described. With reference to the embodiment of the invention shown in FIG. 4, the file location management functions in the inventive CFS system are performed by the metadata management module 7010, which constitutes a part of the CFS server 7001. In an alternative embodiment, a File Locator module may be implemented and configured to communicate the file location information with one or more metadata management modules.

In an embodiment of the inventive system, the metadata management module 7010 of each CFS Server Node 7000 exchanges its local file location information with other peer metadata management modules executing on other CFS Server Nodes 7000. The exchanged file location information may include, for example, local index node (inode) information for a file, which includes the attribute part of a file. By means of the aforementioned location information exchange, all metadata management modules have access to current file location information for all files stored within the CFS. As will be appreciated by those of skill in the art, not all inode file information needs to be exchanged in order to enable the location information sharing. Specifically, in one embodiment of the inventive concept, the inventive system exchanges only the file location information.

In an alternative embodiment of the inventive CFS system, each CFS server performs file storage operations and manages file location information for all files associated with that CFS server. In such a configuration, no single CFS server has global file location information. When a CFS server receives a request to perform a storage operation with respect to a file associated with a different CFS server, it randomly forwards the received request to another CFS server. If the receiving CFS server still does not have the required file, it again randomly forwards the storage operation request to yet another CFS server. The described forwarding operation continues until the required file is found or until the system finally determines that the required file is not within the CFS.

In yet another embodiment, the inventive CFS system includes a separate metadata server. This metadata server is configured to handle all of the location information in a cluster. A CFS client requiring a storage-related operation to be performed on a specific file, first requests the aforesaid metadata server to furnish the current file location information, and then uses this location information to either query a CFS server controlling the access to the target file or to directly access the storage system which stores the file.

It should be noted that in the embodiments of the inventive concept shown in the figures and the accompanying description, each CFS server is aware of the location information on all files within the CFS. However, it would be appreciated by skilled in the art that the invention is not so limited. In another, alternative implementation of the invention, the file location information may be shared among multiple file servers using an appropriate sharing algorithm, as described above.

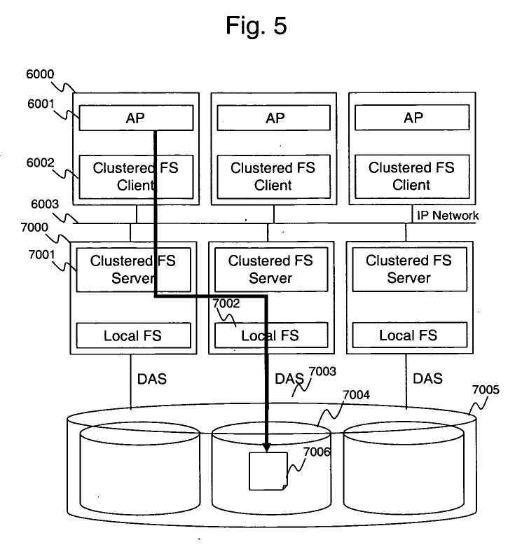

FIG. 5 shows a conceptual diagram illustrating an operating sequence associated with a procedure for reading a file in accordance with an exemplary embodiment of the inventive CFS. First, the CFS client 6002 receives a file system read operation request from the user application 6001. After receiving this request, the CFS client 6002 sends a read request to a pre-determined CFS server 7001. In response, the CFS server 7001 looks up the location information on the requested file and, if the identified file is located on the same node 7000, the CFS server 7001 sends the file read request to the Local File System of its own node 7000. If the designated file is not located on the same node, the CFS server 7001 forwards the file read request to another CFS server 7001, according to the file location information. Subsequently, the CFS server which receives the forwarded read request sends this read request to its Local File System 7002. Finally, the Local File System 7002 reads the designated file 7006 from the attached storage volume 7004, and sends the file back to the requesting client 6002, which provides it to the user application 6001.

A CFS client 6002 can send a read request to an arbitrarily selected CFS server 7001 instead of any pre-determined server in order to achieve uniform balancing of the load among various CFS server nodes. As would be appreciated by those of skill in the art, in such a configuration, the file lookup operations in the CFS servers are performed in a similar manner.

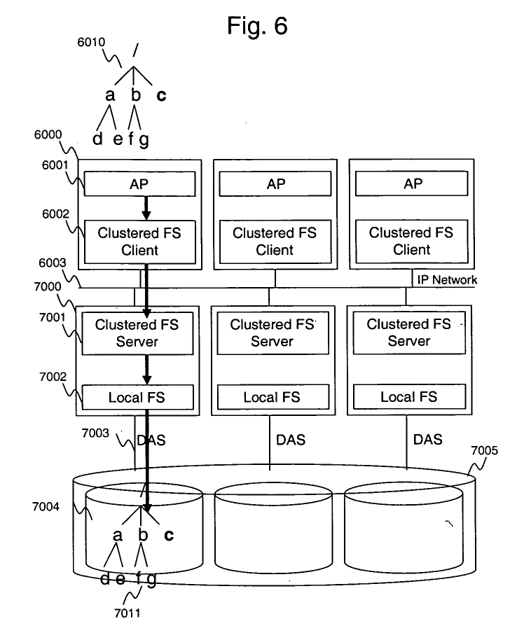

FIG. 6 depicts a conceptual diagram of file creation operation in a CFS. With reference to FIG. 6, user application 6001 creates a new file “c” within a directory tree 6010. Initially, the user application 6001 sends a file creation request to the CFS client 6002 executing on the client node 6000. The CFS client then sends the request to a specific CFS server 7001, which is associated with the client host by means of a mounting operation performed by the client. The mounted CFS server node 7000 is usually fixed. However, under certain circumstances, it may possible to switch the client to another CFS server node. In either case, the CFS server which receives the file creation request from the client 6002 can only forward this request the local File System 7002 of its own server node 7000. Finally, upon the receipt of the forwarded request, the local File System 7002 creates the file “c” in the appropriate folder of the attached storage volume 7004. As long as the storage resources are available on the storage volume 7004 associated with the mounted file server, files are created on the same storage volume. When this storage volume becomes full, the CFS server selects another storage volume to create new files. The selection of the new storage volume depends on the specifics of implementation of the CFS.

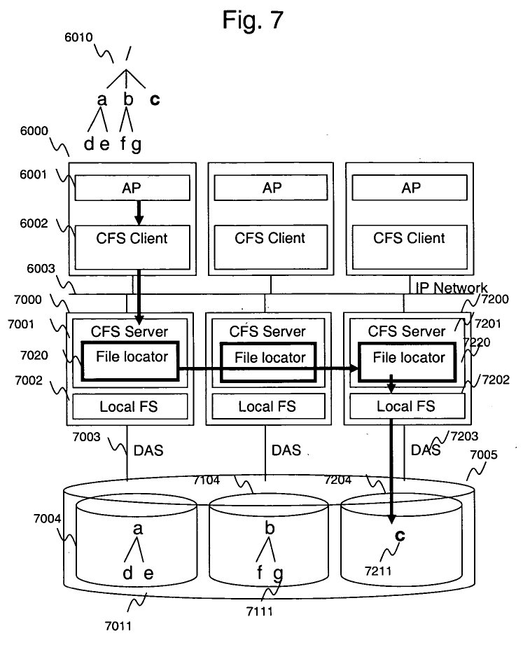

An inventive technique for allocating a file according to a user designated policy will now be described. FIG. 7 presents a conceptual diagram of a file creation sequence in an embodiment of the inventive CFS. In the illustrated operating sequence, the user application 6001 creates a new file “c” within the directory tree 6010. First, the user application 6001 sends a file creation request to the CFS client 6002. In response, the CFS client 6002 sends a request to the CFS server 7001, which is mounted by the client. The mount point of the CFS client 6002 is not necessarily fixed.

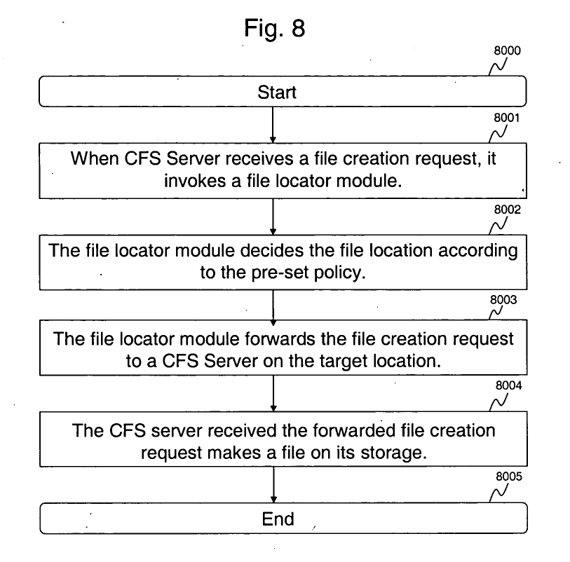

FIG. 8 shows a control sequence of the inventive CFS. When the CFS server 7001 receives a file creation request, it invokes a file locator module 7020, see step 8001 of FIG. 8. At step 8002, the file locator module 7020 determines, in accordance with the implemented policy, on which storage volume of the CFS the file should be allocated. The file locator module may support various file allocation policies, examples of which will be described in detail below. After determining the file location, at step 8003, the CFS server 7020 forwards the file creation request to the CFS server 7220, which controls access to the storage volume where the file is to be allocated. The receiving CFS server 7220 forwards the request to a local file system 7202 of its node 7200. Finally, at step 8004, the local file system creates the file “c” in the attached storage volume 7204. It should be noted that the client application 6001 is not aware of the manner in which the file “c” has been allocated by the inventive file locator module. Therefore, the inventive system may be described as client transparent.

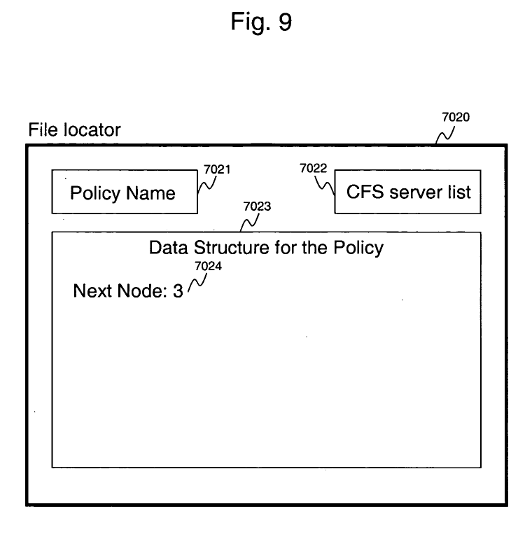

FIG. 9 depicts an exemplary embodiment of data structures associated with the file locator module 7020. In accordance with an embodiment of the inventive technique, the file locator module 7020 supports more than one file allocation policy. In this embodiment, the file locator module 7020 may store information identifying the specific policy or algorithm 7021, which has been selected by the user or administrator of the CFS. In addition, the file locator module 7020 may include a data structure for storing various parameters of each supported allocation algorithm 7023. The data structure 7023 is utilized in conjunction with algorithms such as the counter or pointer for calculating the next allocation node 7024.

In addition, the file locator module may require address information of other server nodes within the CFS in order to forward the file manipulation requests to those nodes. In the CFS server node, the addresses of the other CFS server nodes are usually managed by the metadata management module 7010 shown in FIG. 4, in order to facilitate the exchange of the file location information among different CFS servers. Thus, the file locator module may use the node address information managed by the metadata management module. If there is no such address information available within the CFS server, the file locator may store a list of addresses 7022, which may be supplied by the users of the CFS.

Certain exemplary embodiments of file allocation algorithms will now be described. There can be various storage allocation policies supported by the file locator module 7020. The following algorithms are described for illustrative purposes only and they should not be construed to limit the present invention. It should be also noted that some of the described algorithms are inventive in their nature.

In accordance with one exemplary storage allocation policy, folders under the root directory will be created within the storage volumes in a cluster by way of a round robin-type algorithm, wherein directories are created on storage volumes in a rotating manner. FIG. 7 shows an example of file creation using this policy. It should be noted that in directory structure 6010 shown in this figure, there are three directories under the root directory (depth 1), and specifically directories “a, b, and c”. In the shown example, directory “c” is about to be created. Directory “a” was created in the storage volume 7004, and directory “b” was created in the storage volume 7104. Then, in accordance with the round robin algorithm, directory “c” is created in the storage volume 7204. In the same manner, when the next directory (after directory “c”) under the root folder is created, this directory should be created in the storage volume 7004. The first level directories (depth 2) such as “d, e, f, and g” are created in the same storage of the parent directory. The described directory allocation algorithm facilitates balanced storage capacity utilization, especially when the directory depth as well as the number of files in each directory does not vary significantly.

The second exemplary storage allocation algorithm utilizes the aforesaid round robin algorithm not only for allocating depth 1 directories, but also for allocating directories of any depth. For example, if directories “a” through “g” were created in the following order: “a, b, d, e, f, g, c”, the storage volume assignment for those directories would be the following: “a” in 7004, “b” in 7104, “d” in 7204, “e” in 7004, “f” in 7104, “g” in 7204, and “c” in 7004.

The third exemplary storage allocation policy is depth-based round robin algorithm, in accordance with which the directories of the same depth are created in the same storage volume. For example, if directories “a” through “g” were created in the following order: “a, b, d, e, f, g, c”; the storage volume assignment for those directories would be the following: “a, b, and c” in 7004, and “d, e, f, and g” in 7104.

Yet another exemplary storage allocation policy utilizes a threshold value in conjunction with the above algorithms. For instance, when usage of any specific storage volume is under 50%, the existing assignment policy described below is used. And when the usage of the storage volume exceeds 50%, another allocation algorithm, such as one of the aforementioned round robin-type algorithms is used.

The above description was related primarily to various embodiments of algorithms for directory creation. As would be appreciated by those of skill in the art, the inventive storage allocation rules may also include algorithms for allocating files. In accordance with one exemplary technique, storage resources for files stored under a created directory are allocated in the same storage volume as the directory itself. On the other hand, the aforementioned directory level-dependent storage allocation algorithm may be more suitable for file allocation. Thus, as would be apparent to a skilled artisan, the above described directory creation algorithms may be applied to the allocation of not only directories but also files.

As would be appreciated by those of skill in the art, the described embodiments of various storage allocation algorithms are provided herein by way of example only. Many additional or alternative algorithms may be utilized in conjunction with the inventive framework. The selection of a suitable storage allocation algorithm depends on both the storage administration policy established by the storage system administrator as well as the other implemented functionalities of the CFS, such as the migration functionality (file, directory or volume level). Therefore, the inventive file allocation framework is not restricted by these algorithms.

A procedure for managing the file allocation will now be described. The administrator of the CFS is provided with an ability to select the file allocation algorithm supported by the file locator module, if the file locator provides more than one such file allocation algorithms. The storage management software deployed on the storage management node communicates with other CFS servers through their application programming interfaces (APIs) in order to enable the storage system administrators to select the proper storage allocation algorithm and to set the necessary parameters. If the CFS server includes a command line interface (CLI) or a graphical user interface (GUI), the administrator of the CFS can accomplish the above task through the use of these interfaces by directly accessing the CFS server nodes. Although using the storage management software on the storage management node might be helpful for the administrators, the specific way in which the CFS is manages is not essential to the inventive concept.

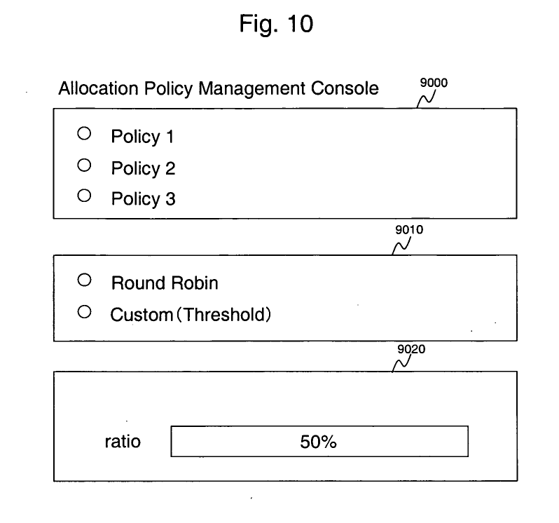

FIG. 10 depicts an exemplary embodiment of a management console which may be used in conjunction with the inventive CFS system. First, the administrator of the inventive CFS may use the aforementioned management console to select one of the implemented allocation policies 9000. After that, a more detailed configuration for the selected policy may be specified by the administrator using console 9010 of the shown interface. If yet more detailed configuration is required, another console 9020 will appear enabling the administrator to specify additional configuration parameters. The selected policy and the specified configured parameters are saved into the data structure of the file locator module shown in FIG. 9.

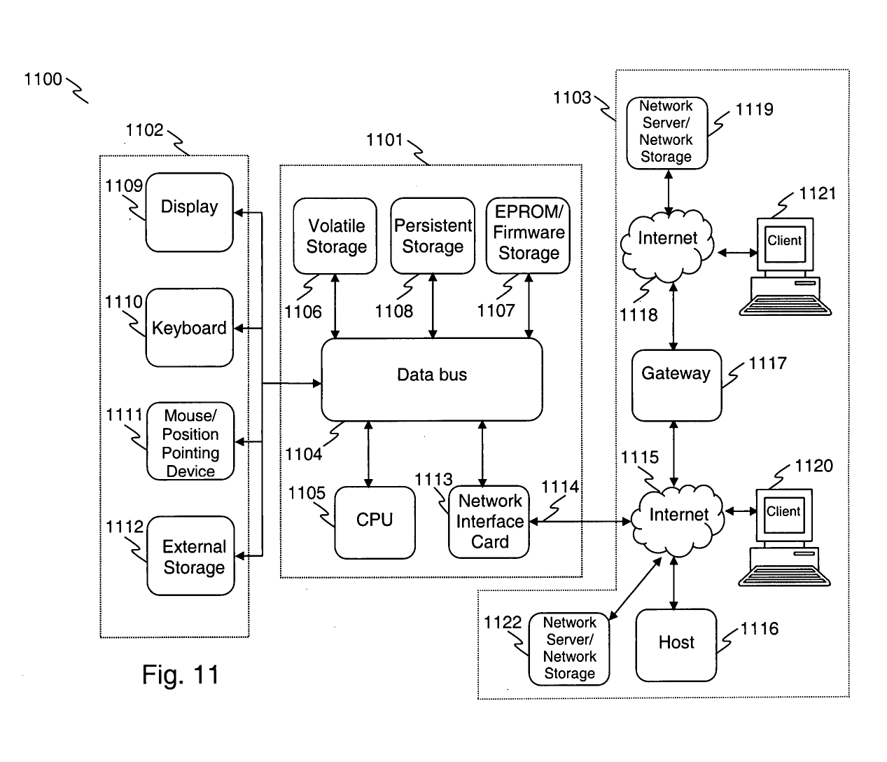

FIG. 11 is a block diagram that illustrates an embodiment of a computer/server system 1100 upon which an embodiment of the inventive methodology may be implemented. The system 1100 includes a computer/server platform 1101, peripheral devices 1102 and network resources 1103.

The computer platform 1101 may include a data bus 1104 or other communication mechanism for communicating information across and among various parts of the computer platform 1101, and a processor 1105 coupled with bus 1101 for processing information and performing other computational and control tasks. Computer platform 1101 also includes a volatile storage 1106, such as a random access memory (RAM) or other dynamic storage device, coupled to bus 1104 for storing various information as well as instructions to be executed by processor 1105. The volatile storage 1106 also may be used for storing temporary variables or other intermediate information during execution of instructions by processor 1105. Computer platform 1101 may further include a read only memory (ROM or EPROM) 1107 or other static storage device coupled to bus 1104 for storing static information and instructions for processor 1105, such as basic input-output system (BIOS), as well as various system configuration parameters. A persistent storage device 1108, such as a magnetic disk, optical disk, or solid-state flash memory device is provided and coupled to bus 1101 for storing information and instructions.

Computer platform 1101 may be coupled via bus 1104 to a display 1109, such as a cathode ray tube (CRT), plasma display, or a liquid crystal display (LCD), for displaying information to a system administrator or user of the computer platform 1101. An input device 1110, including alphanumeric and other keys, is coupled to bus 1101 for communicating information and command selections to processor 1105. Another type of user input device is cursor control device 1111, such as a mouse, a trackball, or cursor direction keys for communicating direction information and command selections to processor 1104 and for controlling cursor movement on display 1109. This input device typically has two degrees of freedom in two axes, a first axis (e.g., x) and a second axis (e.g., y), that allows the device to specify positions in a plane.

An external storage device 1112 may be connected to the computer platform 1101 via bus 1104 to provide an extra or removable storage capacity for the computer platform 1101. In an embodiment of the computer system 1100, the external removable storage device 1112 may be used to facilitate exchange of data with other computer systems.

The invention is related to the use of computer system 1100 for implementing the techniques described herein. In an embodiment, the inventive client node 6000 and/or the inventive server node 7000 may be deployed using a machine such as computer platform 1101. According to one embodiment of the invention, the techniques described herein are performed by computer system 1100 in response to processor 1105 executing one or more sequences of one or more instructions contained in the volatile memory 1106. Such instructions may be read into volatile memory 1106 from another computer-readable medium, such as persistent storage device 1108. Execution of the sequences of instructions contained in the volatile memory 1106 causes processor 1105 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1105 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1108. Volatile media includes dynamic memory, such as volatile storage 1106. Transmission media includes coaxial cables, copper wire and fiber optics, including the wires that comprise data bus 1104. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1105 for execution. For example, the instructions may initially be carried on a magnetic disk from a remote computer. Alternatively, a remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on the data bus 1104. The bus 1104 carries the data to the volatile storage 1106, from which processor 1105 retrieves and executes the instructions. The instructions received by the volatile memory 1106 may optionally be stored on persistent storage device 1108 either before or after execution by processor 1105. The instructions may also be downloaded into the computer platform 1101 via Internet using a variety of network data communication protocols well known in the art.

The computer platform 1101 also includes a communication interface, such as network interface card 1113 coupled to the data bus 1104. Communication interface 1113 provides a two-way data communication coupling to a network link 1114 that is connected to a local network 1115. For example, communication interface 1113 may be an integrated services digital network (ISDN) card or a modem to provide a data communication connection to a corresponding type of telephone line. As another example, communication interface 1113 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1113 sends and receives electrical, electromagnetic or optical signals that carry digital data streams representing various types of information.

Network link 1113 typically provides data communication through one or more networks to other network resources. For example, network link 1114 may provide a connection through local network 1115 to a host computer 1116, or a network storage/server 1117. Additionally or alternatively, the network link 1113 may connect through gateway/firewall 1117 to the wide-area or global network 1118, such as an Internet. Thus, the computer platform 1101 can access network resources located anywhere on the Internet 1118, such as a remote network storage/server 1119. On the other hand, the computer platform 1101 may also be accessed by clients located anywhere on the local area network 1115 and/or the Internet 1118. The network clients 1120 and 1121 may themselves be implemented based on the computer platform similar to the platform 1101.

Local network 1115 and the Internet 1118 both use electrical, electromagnetic or optical signals that carry digital data streams. The signals through the various networks and the signals on network link 1114 and through communication interface 1113, which carry the digital data to and from computer platform 1101, are exemplary forms of carrier waves transporting the information.

Computer platform 1101 can send messages and receive data, including program code, through the variety of network(s) including Internet 1118 and LAN 1115, network link 1114 and communication interface 1113. In the Internet example, when the system 1101 acts as a network server, it might transmit a requested code or data for an application program running on client(s) 1120 and/or 1121 through Internet 1118, gateway/firewall 1117, local area network 1115 and communication interface 1113. Similarly, it may receive code from other network resources.

The received code may be executed by processor 1105 as it is received, and/or stored in persistent or volatile storage devices 1108 and 1106, respectively, or other non-volatile storage for later execution. In this manner, computer system 1101 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the clustered file system. It is intended that the specification and examples be considered as exemplary only, with a true scope and spirit of the invention being indicated by the following claims.

What is claimed is:

1. A clustered file system comprising:
a. a client node executing a user application and a file system client, wherein the file system client is operable to receive a file creation request from the user application and forward this request to a first file system server;
b. a plurality of file server nodes, each of the plurality of server nodes executing a file system server and having local file system, wherein the first file system server comprises a file locator module configured to determine the location of the file within the clustered file system in accordance with a predetermined policy and to forward the file creation request to a second file server associated with the determined file location;
c. a plurality of storage volumes, wherein each of the plurality of storage volumes is associated with one of the plurality of file server nodes; and
d. a network interlinking the client node and the plurality of file server nodes; wherein the second file server is operable, in response to the file creation request, to cause a file to be created within its local file system.

2. The clustered file system of claim 1, wherein the determined file location comprises the second storage volume.

3. The clustered file system of claim 1, wherein the file server further comprises metadata management module operable to exchange file location information with peer metadata management modules of other file servers over the network.

4. The clustered file system of claim 3, wherein the exchanged file location information comprises at least a portion of inode file information.

5. The clustered file system of claim 1, wherein the predetermined policy prescribes storage allocation in accordance with a round-robin algorithm.

6. The clustered file system of claim 1, wherein the predetermined policy prescribes storage allocation in accordance with a degree of utilization of the plurality of storage volumes and a threshold value.

7. The clustered file system of claim 1, wherein the predetermined policy prescribes a storage allocation for a folder in accordance with a depth of the folder.

8. The clustered file system of claim 7, wherein in accordance with the predetermined policy folders of the same depth are allocated within the same storage volume.

9. The clustered file system of claim 1, wherein the plurality of storage volumes are located on a storage device coupled with the plurality of file server nodes by means of a storage area network.

10. The clustered file system of claim 1, wherein the plurality of storage volumes collectively form a logical file system.

11. The clustered file system of claim 1, wherein the plurality of storage volumes are located on a storage device coupled with the plurality of file server nodes by means of a network attached storage configuration.

12. The clustered file system of claim 1, wherein each of the plurality of storage volumes is directly attached to a corresponding one of the plurality of server nodes.

13. The clustered file system of claim 1, wherein the plurality of storage volumes are located on a storage device coupled with the plurality of file server nodes by means of a Fibre Channel interconnect.

14. The clustered file system of claim 1, wherein the file locator module comprises a policy data structure.

15. The clustered file system of claim 14, wherein the policy data structure comprises next file server node information.

16. The clustered file system of claim 1, wherein the file locator module comprises a data structure storing address information on at least one of the plurality of file server nodes.

17. The clustered file system of claim 1, further comprising a metadata management server operable to handle file location information within the clustered file system.

18. The clustered file system of claim 1, wherein at least one of the file system servers comprises a management interface operable to receive from an administrator a selection of the predetermined policy and parameters of the predetermined policy.

19. The clustered file system of claim 1, wherein each of the file system servers comprises an application program interface operable to enable communication between the file system servers over the network.

20. A computer-implemented method for allocating a file within a clustered file system, the clustered file system comprising a client node executing a user application and a plurality of file server nodes, each executing a file server, the method comprising:
a. receiving a file creation request from the user application;
b. determining the location of the file within the clustered file system in accordance with a predetermined policy;
c. forwarding the file creation request to one of the plurality of file server nodes associated with the determined file location; and
d. creating the file at the determined file location in accordance with the file creation request.

21. The method of claim 20, further comprising exchanging file location information between file servers.

22. The method of claim 21, wherein the exchanged file location information comprises at least a portion of inode file information.

23. The method of claim 20, wherein the predetermined policy prescribes storage allocation in accordance with a round-robin algorithm.

24. The method of claim 20, wherein the determined file location comprises a storage volume.

25. The method of claim 20, wherein the predetermined policy prescribes storage allocation in accordance with a degree of utilization of the plurality of storage volumes and a threshold value.

26. The method of claim 20, wherein the predetermined policy prescribes a storage allocation for a folder in accordance with a depth of the folder.

27. The clustered file system of claim 26, wherein in accordance with the predetermined policy folders of the same depth are allocated within the same storage volume.

28. The method of claim 20, further comprising storing next file server node information.

29. The method of claim 20, further comprising storing address information on at least one of the plurality of file server nodes.

30. The method of claim 20, further comprising storing parameters of the predetermined policy.

31. The method of claim 20, further comprising storing multiple policies and information identifying the predetermined policy.

32. The method of claim 20, further comprising receiving from the administrator a selection of the predetermined policy and parameters of the predetermined policy.

33. A computer-readable medium embodying a set of computer instructions, which when executed by a clustered file system, the clustered file system comprising a client node executing a user application and a plurality of file server nodes, cause the clustered file system to:
a. receive a file creation request from the user application;
b. determine the location of the file within the clustered file system in accordance with a predetermined policy;
c. forward the file creation request to one of the plurality of file server nodes associated with the determined file location; and
d. create the file at the determined file location.
